(19) United States
(12) Patent Application Publication
(10) Pub. No.: US 2025/0253602 A1
(43) Pub. Date: Aug. 7, 2025

(54) TRACK CONNECTOR POWER SUPPLY MODULE

(71) Applicant: DONGGUAN JIASHENG LIGHTING TECHNOLOGY CO., LTD., Dongguan City (CN)

(72) Inventor: CHIH-PIN HSU, Dongguan City (CN)

(73) Assignee: DONGGUAN JIASHENG LIGHTING TECHNOLOGY CO., LTD., Dongguan City, GD (CN)

(21) Appl. No.: 19/189,249

(22) Filed: Apr. 24, 2025

(30) Foreign Application Priority Data
Mar. 13, 2025 (CN) CN202520447182.0

(51) Int. Cl. H01R 25/14; F21V 23/06; H01R 33/94

(52) U.S. Cl. CPC H01R 25/142; H01R 25/145; H01R 33/94; F21V 23/06; H01R 2201/00

(57) ABSTRACT

Disclosed is a track connector power supply module, including a sliding assembly, a rotary assembly, and a conductive assembly; the sliding assembly is configured to match a conductive track, and an electrical device slides along the conductive track through the sliding assembly; the rotary assembly is sleeved on an outer side of the sliding assembly, and is capable of rotating about the sliding assembly; a mounting surface is formed on an outer side of the rotary assembly, a connecting structure is disposed around the mounting surface, and the electrical device is detachably connected to the rotary assembly via the connecting structure; one end of the conductive assembly is disposed on a side of the sliding assembly facing the conductive track and abuts against the conductive track, and the other end of the conductive assembly extends through the mounting surface and is electrically connected to the electrical device.

### TECHNICAL FIELD

The present disclosure relates to the technical field of mounting electrical devices on a conductive track, and particularly relates to a track connector power supply module.

### BACKGROUND

By using a conductive track as a power source and combining it with an annular conductive ring, a lighting structure capable of supporting 360° rotational illumination is achieved, and the structure can accommodate a variety of electrical devices without taking up too much space. In the prior art, a conductive ring is mounted on an electrical device, which is then fitted on the conductive track, such that a plurality of electrical devices can be mounted in a small space. However, once different electrical devices are mounted on the conductive track in a predetermined order, it is impossible to rearrange the positions of an individual electrical device. To change the order of the different electrical devices, all of them must first be removed from the conductive track and then remounted, which makes the operation cumbersome and inconvenient. Therefore, the prior art needs to be further improved and developed.

### SUMMARY

The present disclosure aims to provide a track connector power supply module to address the deficiencies in the prior art. In the prior art, when it is necessary to change an order of electrical devices on a conductive track, the corresponding electrical device needs to be removed from the conductive track and then remounted, making the operation cumbersome and inconvenient.

The technical solution of the present disclosure is as follows:

a track connector power supply module, where the track connector power supply module may be sleeved on a conductive track in a sliding manner to fix an electrical device on the conductive track and provide an electrical connection for the electrical device, including:

a sliding assembly, where the sliding assembly is configured to match the conductive track, and the electrical device slides along the conductive track through the sliding assembly;

a rotary assembly, where the rotary assembly is sleeved on an outer side of the sliding assembly, and the rotary assembly is capable of rotating about the sliding assembly; where a mounting surface is formed on an outer side of the rotary assembly, a connecting structure is disposed around the mounting surface, and the electrical device is detachably connected to the rotary assembly via the connecting structure; and

a conductive assembly, where one end of the conductive assembly is disposed on a side of the sliding assembly facing the conductive track and abuts against the conductive track, and the other end of the conductive assembly extends through the mounting surface and is electrically connected to the electrical device.

In one embodiment, the conductive assembly includes:

a first conductive bump, where the first conductive bump is fixed in the sliding assembly and extends from the sliding assembly toward the conductive track to abut against the conductive track;

a conductive structure, where the conductive structure is disposed between the sliding assembly and the rotary assembly, and one side of the conductive structure is connected to the first conductive bump; and

a second conductive bump, where the second conductive bump is fixed in the rotary assembly, one end of the second conductive bump keeps abutting against the other side of the conductive structure when the rotary assembly rotates, and the other end of the second conductive bump extends through the mounting surface and is electrically connected to the electrical device.

In one embodiment, a spring plunger is disposed inside each of the first conductive bump and the second conductive bump to ensure that the first conductive bump always extends from the sliding assembly to abut against the conductive track, and ensure that the second conductive bump always extends from the rotary assembly to abut against the conductive structure.

In one embodiment, the sliding assembly includes:

a body, where the body is an annular structure to be sleeved on the conductive track;

a boss, where the boss is disposed on an inner side of the body and is snap-fitted with the conductive track; and when the sliding assembly slides along the conductive track, the boss is configured to ensure that the sliding assembly and the conductive track do not rotate relative to each other; and

an annular rib, where the annular rib is disposed around the body on a circumference of the body, and the annular rib is assembled with the body to form the conductive structure.

In one embodiment, two first bump through-holes penetrating through the body are formed on the boss, and the first conductive bump is fixed in the first bump through-holes, and the first bump through-holes are disposed on both sides of the annular rib to correspond to the conductive structures respectively disposed on both sides of the annular rib; where the conductive structure is a copper wire ring, and the two conductive structures are disposed around the body on both sides of the annular rib.

In one embodiment, the rotary assembly is an annular structure, an inner side of the rotary assembly is provided with a receiving groove in a circumferential direction to accommodate the sliding assembly and the conductive structure, and the second conductive bump abuts against the conductive structure, such that the sliding assembly and the conductive structure are eccentrically disposed relative to the rotary assembly, the track connector power supply module is locked on the conductive track.

In one embodiment, an unlocking member is disposed on a side of the rotary assembly away from the mounting surface, the unlocking member abuts against the sliding assembly to push the unlocking member to move toward the sliding assembly and the conductive structure, such that the sliding assembly and the conductive structure are concentrically disposed relative to the rotary assembly to unlock the track connector power supply module from the conductive track.

In one embodiment, a snap-fit slot is formed between the mounting surface and the rotary assembly as the connecting structure, so as to match the electrical device, and enable detachable connection between the electrical device and the rotary assembly.

In one embodiment, two second bump through-holes penetrating through the rotary assembly are formed on the mounting surface, the second bump through-holes are respectively disposed corresponding to the conductive structures on both sides of the annular rib, and the second conductive bump is fixed in the second bump through-holes.

In one embodiment, a mounting groove is formed on the side of the mounting surface away from the rotary assembly, and a spring latch is fixedly disposed in the mounting groove, so as to secure the electrical device when the electrical device is connected to the rotary assembly.

Compared with the prior art, the present disclosure provides a track connector power supply module, including a sliding assembly configured to match the conductive track, and the electrical device sliding along the conductive track through the sliding assembly; a rotary assembly sleeved on an outer side of the sliding assembly, and the rotary assembly capable of rotating about the sliding assembly; where a mounting surface is formed on an outer side of the rotary assembly, a connecting structure is disposed around the mounting surface, and the electrical device is detachably connected to the rotary assembly via the connecting structure; and a conductive assembly, one end of the conductive assembly is disposed on a side of the sliding assembly facing the conductive track and abuts against the conductive track, and the other end of the conductive assembly extends through the mounting surface and is electrically connected to the electrical device. By setting up a modular electrical connector structure, the present disclosure simplifies the steps of changing the order of different electrical devices on the conductive track, that is, it is only necessary to remove the corresponding electrical device from the conductive track and remount on a desired position, with no need to remove all the electrical devices from the conductive track and mount again, making the operation more convenient and efficient.

### BRIEF DESCRIPTION OF THE DRAWINGS

FIG. 1 is a perspective schematic view of a track connector power supply module mounted on a conductive track according to one embodiment of the present disclosure.

FIG. 2 is a perspective schematic view of a track connector power supply module mounted on a conductive track and connected to different electrical devices according to one embodiment of the present disclosure.

FIG. 3 is a schematic top view of a track connector power supply module fixed on a conductive track according to one embodiment of the present disclosure.

FIG. 4 is a sectional view of a track connector power supply module connected to an electrical device according to one embodiment of the present disclosure.

FIG. 5 is a schematic diagram of separating a track connector power supply module from an electrical device according to one embodiment of the present disclosure.

FIG. 6 is one exploded view of a track connector power supply module according to one embodiment of the present disclosure.

FIG. 7 is another exploded view of a track connector power supply module according to one embodiment of the present disclosure.

FIG. 8 is one exploded view of a track connector power supply module from another direction according to one embodiment of the present disclosure.

FIG. 9 is a schematic top view of a track connector power supply module after being unlocked relative to a conductive track according to one embodiment of the present disclosure.

### DETAILED DESCRIPTIONS OF THE EMBODIMENTS

The present disclosure provides a track connector power supply module. In order to make the objectives, technical solutions, and effects of the present disclosure clearer, the present disclosure will be further described in detail below. It should be understood that the specific embodiments described herein are merely used to explain the present disclosure and are not intended to limit the present disclosure.

It should be noted that the terms “center”, “upper”, “lower”, “left”, “right”, “inner”, “outer”, “vertical”, “horizontal”, etc. indicate azimuthal or positional relations on the basis of those shown in the drawings only for ease of description of the present disclosure and for simplicity of description, and are not intended to indicate or imply that the referenced structure must have a particular orientation and be constructed in a particular orientation, and thus may not be construed as a limitation on the present disclosure.

In addition, unless otherwise specified for the articles in the context, “a/an” and “the” can generally refer to either a single or multiple instances. Under the condition that embodiments of the present disclosure involve descriptions of “first”, “second”, etc., the descriptions of “first”, “second”, etc. are for descriptive purposes only and are not to be construed as indicating or implying their relative importance or implicitly specifying the number of indicated technical features. Thus, a feature defined with “first” and “second” may explicitly or implicitly include at least one of the features. In addition, the technical solutions of the embodiments may be combined with one another, which must be based on the achievement by those of ordinary skill in the art, and when the combinations of the technical solutions contradict one another or cannot be achieved, it should be considered that the combinations of the technical solutions do not exist and do not fall within the scope of protection claimed in the present disclosure.

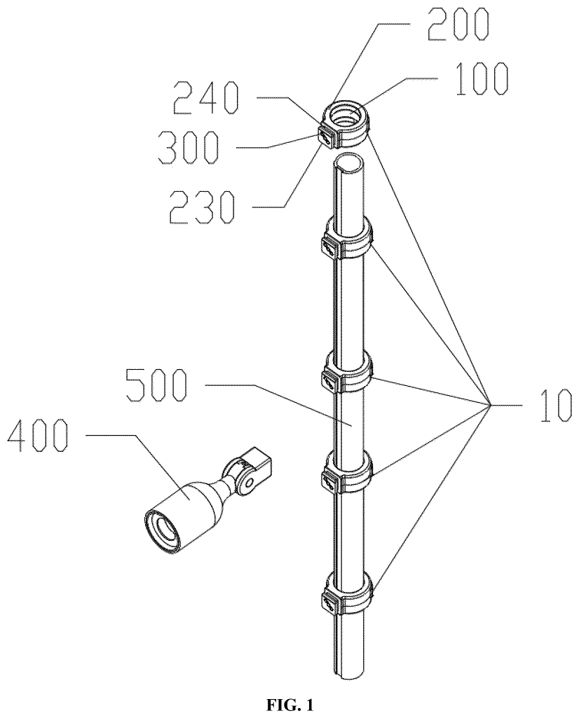

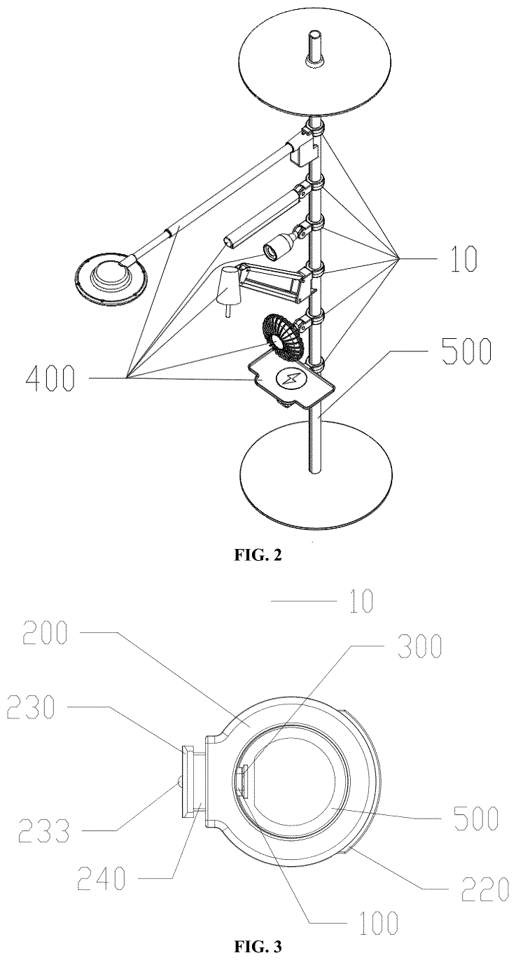

The present disclosure provides a track connector power supply module, as shown in FIGS. 1 and 2, the track connector power supply module 10 is sleeved on a conductive track 500 in a sliding manner to fix an electrical device 400 on the conductive track 500 and provide an electrical connection for the electrical device. Specifically, as shown in FIGS. 3 and 5, the track connector power supply module 10 includes: a sliding assembly 100, a rotary assembly 200, and a conductive assembly 300. Specifically, the sliding assembly 100 is configured to match the conductive track 500, and the electrical device 400 slides along the conductive track 500 through the sliding assembly 100; the rotary assembly 200 is sleeved on an outer side of the sliding assembly 100, and the rotary assembly 200 can rotate about the sliding assembly 100. Specifically, a mounting surface 230 is formed on an outer side of the rotary assembly 200, a connecting structure 240 is disposed around the mounting surface 230, and the electrical device 400 is detachably connected to the rotary assembly 200 via the connecting structure 240; and one end of the conductive assembly 300 is disposed on a side of the sliding assembly 100 facing the conductive track 500 and abuts against the conductive track 500, and the other end of the conductive assembly 300 extends through the mounting surface 230 and is electrically connected to the electrical device 400. By using the cooperation of the sliding assembly 100 and the rotary assembly 200, the electrical device 400 is positioned on the conductive track 500, and the conductive assembly 300 enables the electrical connection between the electrical device 400 and the conductive track 500, such that normal operation of the electrical device 400 is ensured; and finally, through the detachable connection between the electrical device 400 and the mounting surface 230 of the rotary assembly 200 in the track connector power supply module 10, it is only necessary to remove the electrical device 400 from an original track connector power supply module 10 and then mount it on the corresponding track connector power supply module 10 when an order among different electrical devices 400 needs to be changed, such that the order of electrical devices can be adjusted with no need to remove all the electrical devices from the conductive track 500, making the module convenient and easy to use.

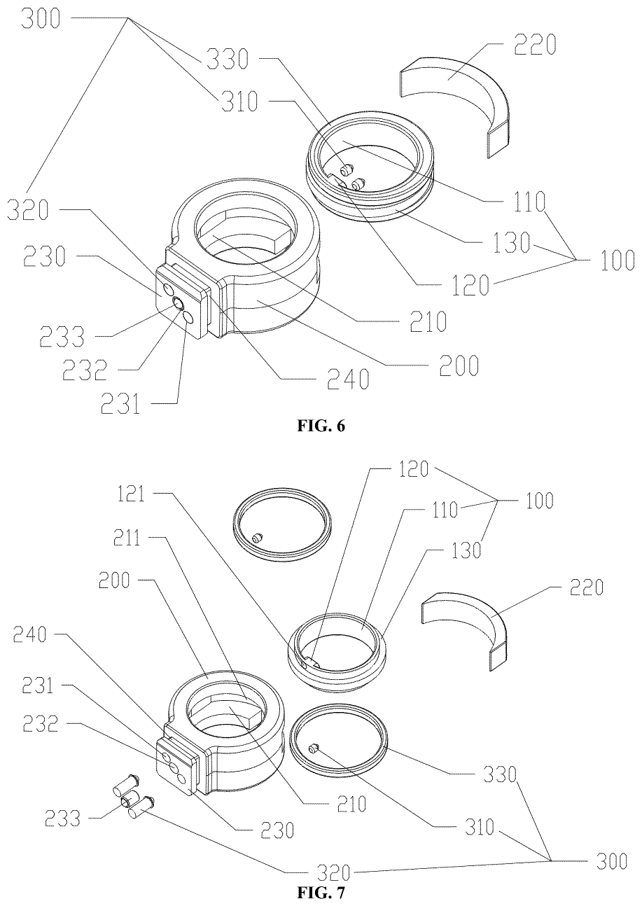

In one embodiment, as shown in FIGS. 6 and 7, the conductive assembly 300 includes a first conductive bump 310, a second conductive bump 320, and a conductive structure 330. Specifically, the first conductive bump 310 is fixed in the sliding assembly 100 and extends from the sliding assembly 100 toward the conductive track 500 to abut against the conductive track 500; the conductive structure 330 is disposed between the sliding assembly 100 and the rotary assembly 200, one side of the conductive structure 330 is connected to the first conductive bump 310; and the second conductive bump 320 is fixed in the rotary assembly 200, one end of the second conductive bump 320 keeps abutting against the other side of the conductive structure 330 when the rotary assembly 200 rotates, and the other end of the second conductive bump 320 extends through the mounting surface 230 and is electrically connected to the electrical device 400. By arranging the first conductive bump 310, the conductive structure 330, and the second conductive bump 320 which abuts against each other in sequence, and ensuring that the first conductive bump 310 always abuts against the conductive track 500, and the second conductive bump 320 is always connected to the electrical device 400, it is ensured that when the track connector power supply module 10 slides along the conductive track 500 or rotates around the conductive track 500, the track connector power supply module 10 can stably realize an electrical connection between the electrical device 400 and the conductive track 500, allowing the corresponding electrical device to operate on the conductive track 500.

In one embodiment, a spring plunger is disposed inside each of the first conductive bump 310 and the second conductive bump 320 to ensure that the first conductive bump 310 always extends from the sliding assembly 100 to abut against the conductive track 500, and ensure that the second conductive bump 320 always extends from the rotary assembly 200 to abut against the conductive structure 330. Optionally, the spring plunger is disposed inside the first conductive bump 310 and the second conductive bump 320, each of the first conductive bump 310 and the second conductive bump 320 is provided with a movable end capable of performing telescopic movement relative to a whole, and the movable ends abut against the conductive track 500 and the conductive structure 330 respectively under the action of elastic force of the spring plunger, so as to ensure when the track connector power supply module 10 slides along the conductive track 500 or rotates relative to the conductive track 500, the first conductive bump 310 maintains electrical connection with the conductive track 500, and the second conductive bump 320 maintains electrical connection with the conductive structure 330, thereby ensuring the electrical connection between the corresponding electrical device and the conductive track 500, and ensuring stable operation of the electrical device.

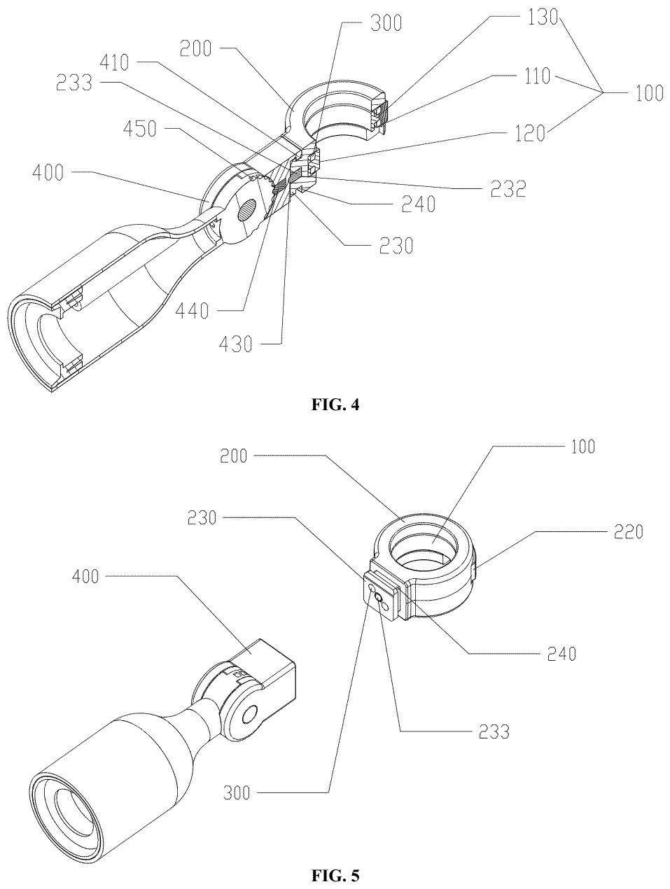

In one embodiment, as shown in FIGS. 4 and 6, the sliding assembly 100 includes a body 110, a boss 120, and an annular rib 130. Specifically, the body 110 is an annular structure to be sleeved on the conductive track 500; the boss 120 is disposed on an inner side of the body 110 and is snap-fitted with the conductive track 500, and when the sliding assembly 100 slides along the conductive track 500, the boss 120 is configured to ensure that the sliding assembly 100 and the conductive track 500 do not rotate relative to each other; and the annular rib 130 is disposed around the body 110 on a circumference of the body 110, and the annular rib 130 is assembled with the body 110 to form the conductive structure 330. By introducing the sliding assembly 100, the present disclosure ensures the stability of the track connector power supply module 10 during the process of sliding along the conductive track 500, and the conductive structure 330 is stabilized and fixed between the sliding assembly 100 and the rotary assembly 200, thereby ensuring stable power supply to the corresponding electrical device.

In one embodiment, as shown in FIGS. 7 and 8, the boss 120 is provided with two first bump through-holes 121 penetrating through the body 110, and the first conductive bump 310 is fixed in the first bump through-holes 121, and the first bump through-holes 121 are disposed on both sides of the annular rib 130 to correspond to the conductive structures 330 respectively disposed on both sides of the annular rib 130; where the conductive structure 330 is a copper wire ring, and the two conductive structures 330 are disposed around the body 110 on both sides of the annular rib 130. An outer surface of the body 110 is divided into two areas by the annular rib 130 to accommodate the two conductive structures 330, respectively, and each of the conductive structures correspond to one of the first conductive bump 310 in one of the first bump through-hole 121, it is thus ensured that there are two paths in the conductive assembly 300, guaranteeing the electrical connection between the electrical device and the conductive track 500.

In one embodiment, as shown in FIGS. 7 and 8, the rotary assembly 200 is an annular structure, and an inner side of the rotary assembly 200 is provided with a receiving groove 210 in a circumferential direction to accommodate the sliding assembly 100 and the conductive structure 330. The receiving groove 210 is configured to accommodate the sliding assembly 100 and the conductive structure 330, so as to ensure that the rotary assembly 200 can rotate relative to the sliding assembly 100, which in turn drives the connected electrical device to rotate relative to the conductive track, enabling the placement of the electrical devices in 360°, for example, for 360° lighting. Further, an inner diameter of the receiving groove 210 is greater than outer diameters of the sliding assembly 100 and the conductive structure 330, so as to ensure that both the sliding assembly 100 and the conductive structure 330 can move in the receiving groove 210 in a radial plane relative to the rotary assembly 200. As shown in FIGS. 3 and 4, under the action of the spring plunger in the second conductive contact 320, the sliding assembly 100 and the conductive structure 330 are eccentrically disposed relative to the rotary assembly 200, that is, central hole structures of the sliding assembly 100 and the conductive structure 330 are misaligned with a central hole structure of the rotary assembly 200, so as to increase friction between the sliding assembly 100, as well as the rotary assembly 200, and the conductive track 500, and lock the track connector power supply module 10 in a specific position on the conductive track 500.

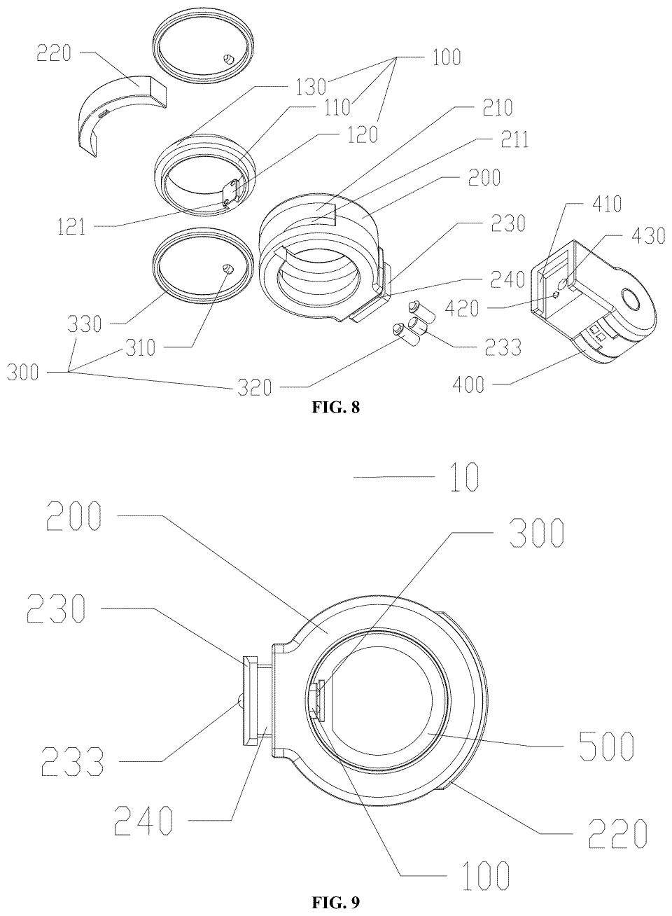

In one embodiment, as shown in FIGS. 5 and 6, an unlocking member 220 is disposed on a side of the rotary assembly 200 away from the mounting surface 230, the unlocking member 220 abuts against the sliding assembly 100, and can perform telescopic movement relative to an axial direction of the rotary assembly 200 to push the sliding assembly 100 and the conductive structure 330 to move toward or away from the mounting surface 230. As shown in FIG. 9, when the unlocking member 220 is pressed, the sliding assembly 100 and the conductive structure 330 move toward the mounting surface 230 to be concentrically disposed relative to the rotary assembly 200, that is, the central hole structures of the sliding assembly 100 and the conductive structure 330 are aligned with the central hole structure of the rotary assembly 200, so as to unlock the track connector power supply module 10 from the conductive track 500, in which case, the track connector power supply module 10 can slide freely along the conductive track 500. After the track connector power supply module 10 is moved to a desired position on the conductive track 500, the unlocking member 220 is released, as shown in FIG. 3, the sliding assembly 100 and the conductive structure 330 move away from the mounting surface 230 under the action of the spring plunger in the second conductive bump 320, in which case, the sliding assembly 100 and the conductive structure 330 are eccentrically disposed relative to the rotary assembly 200 again, so as to lock the track connector power supply module 10 in the desired position on the conductive track 500. The unlocking member 220 cooperates with the second conductive bump 320 to achieve the locking and unlocking of the track connector power supply module 10 relative to the conductive track 500. When the unlocking member 220 is pressed, the unlocking member 220 pushes the sliding assembly 100 and the conductive structure 330 into align with the rotary assembly 200, to enable the track connector power supply module 10 to move along the conductive track 500; when the unlocking member 220 is released, the second conductive bump 320 pushes the sliding assembly 100 and the conductive structure 330 to deviate relative to the rotary assembly 200, and friction is used to keep the track connector power supply module 10 and the conductive track 500 stationary in place, such that the track connector power supply module 10 is locked in a corresponding position on the conductive track 500, and the corresponding electrical device is fixed; and no matter whether in a locked state or a unlocking state, the second conductive bump 320 always abuts against the conductive structure 330, so as to ensure that the conductive track 500 supplies power to the electrical device.

In one embodiment, a snap-fit slot is formed between the mounting surface 230 and the rotary assembly 200 as the connecting structure 240, so as to match the electrical device, and enable detachable connection between the electrical device and the rotary assembly. Specifically, a snap-fit structure matching the snap-fit slot is disposed on the electrical device to enable a detachable connection between the electrical device 400 and the track connector power supply module 10, such that an order of different electrical devices can be easily and quickly adjusted, which is simple to operate.

In one embodiment, as shown in FIGS. 6 and 7, two second bump through-holes 231 penetrating through the rotary assembly 200 are formed on the mounting surface 230, the second bump through-holes 231 are respectively disposed corresponding to the conductive structures 330 on both sides of the annular rib 130, and the second conductive bump 320 is fixed in the second bump through-holes 231. By matching the two second bump through-holes 231 with the two conductive structures 330 in a one-to-one manner, the second conductive bumps 320 and the conductive structures 330 also realize a one-to-one correspondence, so as to ensure that two paths are formed in the conductive assembly 300, and guarantee an electrical connection between the electrical device and the conductive track.

In one embodiment, as shown in FIGS. 3 and 6, a mounting groove 232 is formed on the side of the mounting surface 230 away from the rotary assembly 200, and a spring latch 233 is fixedly disposed in the mounting groove 232, so as to lock the electrical device 400 when the electrical device 400 is connected to the rotary assembly 200. By setting the spring latch 233, when the electrical device 400 is mounted on the mounting surface 230, the spring latch 233 retracts and shrinks into the mounting groove 232, such that the electrical device 400 can be mounted on the rotary assembly 200; and when the mounting groove 232 aligns with a latching notch on the electrical device 400, the spring latch 233 rebounds and engages with the latching notch, so as to lock the electrical device 400 with the mounting surface 230, and complete the mounting of the electrical device 400 on the track joint power module. When the electrical device 400 needs to be removed, the electrical device 400 is moved, such that the spring latch 233 is retracted into the mounting groove 232, and the electrical device 400 is thus separated from the mounting surface 230. In such a way, the electrical device can be quickly mounted and removed, and the order of different electrical devices can be easily and quickly changed.

The structural arrangement and usage of the track connector power supply module 10 In the present disclosure are described below in conjunction with specific embodiments.

In this embodiment, as shown in FIGS. 3 and 5, the track connector power supply module 10 includes a sliding assembly 100, a rotary assembly 200, and a conductive assembly 300, and is sleeved on a conductive track 500 in an axial direction of the conductive track 500. Specifically, the conductive track 500 is fixed on one side of a hollow cylinder, the sliding assembly 100 and the rotary assembly 200 are disposed in a circular ring, the sliding assembly 100 is sleeved outside the conductive track 500 and can slide in an axial direction of the conductive track 500, and the rotary assembly 200 surrounds the sliding assembly 100 and can rotate about the conductive track 500. Further, a mounting surface 230 is formed on an outer side of the rotary assembly 200, a connecting structure 240 is disposed between the mounting surface 230 and the rotary assembly 200, the track connector power supply module 10 is detachably connected to the electrical device 400 through the connecting structure 240, and the electrical device 400 is electrically connected to the conductive track 500 through the conductive assembly 300, so as to ensure that the electrical device 400 can follow the track connector power supply module 10 to move along the conductive track 500 and rotate about the conductive track 500, and the electrical device 400 remains powered during the movement or rotation. By supplying power to the electrical device 400, an object suspended or placed on the track connector power supply module 10 can be charged, or lighting can be provided to a surrounding environment, such that the track connector power supply module 10 has more functions, and can be applied to different scenarios, which is beneficial for market promotion.

Further, as shown in FIGS. 7 and 8, the sliding assembly 100 includes a body 110, a boss 120, and an annular rib 130, the body 110 is an annular structure corresponding to the conductive track 500, and an inner diameter of the body 110 is slightly greater than an outer diameter of the conductive track 500, so as to ensure that the sliding assembly 100 can slide freely along the conductive track 500, and guarantee that the electrical device 400 can slide along the conductive track 500 via the track connector power supply module 10. Further, the boss 120 is disposed corresponding to the conductive track 500 and is adapted to a groove that fixes the conductive track 500, so as to realize a snap-fit connection between the sliding assembly 100 and the conductive track 500, and to ensure that the sliding assembly 100 does not rotate relative to the conductive track 500 when the sliding assembly 100 slides along the conductive track 500, that is, the boss 120 always remains corresponding to the conductive track 500, so as to ensure that the conductive track 500 always maintains the electrical connection with the conductive assembly 300, and continuously supplies power to the electrical device 400 when the electrical device 400 slides along the track connection power module. Further, the boss 120 provides a positioning function for the sliding assembly 100. When the track connector power supply module 10 is assembled, the boss 120 only needs to be clamped in the corresponding groove of the conductive track 500, which can ensure a positional relationship between the sliding assembly 100 and the conductive track 500, thereby completing the mounting of the track connector power supply module 10, the overall mounting process is convenient, fast and easy to operate.

Further, as shown in FIGS. 6 and 7, the annular rib 130 is disposed around an outer wall of the body 110 at a circumference of the body 110, and the outer wall of the body 110 is thus divided into an upper portion and a lower portion. Specifically, two first bump through-holes 121 are formed on the boss 120, such that the conductive assembly 300 can pass through the sliding assembly 100 and is electrically connected to the conductive track 500. Further, the first bump through-holes 121 are respectively disposed on both sides of the annular rib 130, that is, corresponding to the upper portion and the lower portion of the body 110 respectively, such that two parallel conductive paths are formed for the conductive assembly 300.

Further, as shown in FIGS. 7 and 9, the rotary assembly 200 is sleeved on an outer side of the sliding assembly 100, and the rotary assembly 200 can rotate about the conductive track 500. Specifically, the rotary assembly 200 is provided with a receiving groove 210 on an inner side corresponding to the sliding assembly 100 in an axial direction to accommodate the sliding assembly 100, and allow the rotary assembly 200 to follow the sliding assembly 100 to move in the axial direction of the conductive track 500, thereby ensuring that the rotary assembly 200 can rotate relative to the sliding assembly 100 on a radial plane of the conductive track 500. Further, an inner diameter of the receiving groove 210 is greater than an outer diameter of the sliding assembly 100, and the sliding assembly 100 is eccentrically disposed relative to the rotary assembly 200; and an opening 211 is formed on the other side of receiving groove 210 opposite to the mounting surface 230, an unlocking member 220 is disposed corresponding to the opening 211, the unlocking member 220 is disposed corresponding to the annular rib 130 of the sliding assembly 100, and can perform telescopic movement from the opening 211 in an axial direction of the rotary assembly 200. When the unlocking member 220 is not pressed, the sliding assembly 100 and the rotary assembly 200 are eccentrically disposed, and the conductive track 500 is clamped between the sliding assembly 100 and the rotary assembly 200, such that a position of the sliding assembly 100 on the conductive track 500 is locked. In addition, friction between the sliding assembly 100 and the rotary assembly 200 can lock an orientation of the rotary assembly 200 on the sliding assembly 100, such that position and orientation of the track connector power supply module 10 on the conductive track 500 are accordingly locked. When the unlocking member 220 is pressed, the sliding assembly 100 moves to be aligned concentrically with the rotary assembly 200, the sliding assembly 100 and the rotary assembly 200 are both separated from the conductive track 500, such that the sliding assembly 100 can move freely along the conductive track 500, and the rotary assembly 200 can rotate relative to the sliding assembly 100, and it is thus convenient for a user to adjust the position and orientation of the track connector power supply module 10 on the conductive track 500.

In addition, in this embodiment, as shown in FIGS. 4 and 5, the connecting structure 240 between the mounting surface 230 and the rotary assembly 200 is a snap-fit slot, and the mounting surface 230 and the rotary assembly 200 form an “I-shaped” structure to adapt to a snap-fit structure on the electrical device 400, and further to realize a detachable connection between the electrical device 400 and the track connector power supply module 10. Further, two second bump through-holes 231 and one mounting groove 232 are formed on the mounting surface 230. In this embodiment, the second bump through-holes 231 are symmetrically disposed relative to the mounting groove 232, and the second bump through-holes 231 are respectively disposed corresponding to the upper portion and the lower portion divided by the annular rib 130 in the sliding assembly 100, to enable the conductive assembly 300 to pass through the sliding assembly 100 and electrically connect to the conductive track 500, and provide two parallel conductive paths for the conductive assembly 300. Further, as shown in FIGS. 4 and 6, a spring latch 233 is disposed in the mounting groove 232 contains, and the spring latch 233 can perform telescopic movement relative to a surface of the mounting surface 230; and when force is applied, the spring latch 233 is retracted into the mounting groove 232, to facilitate the mounting of the electrical device 400 on the track connector power supply module 10 through the mounting surface 230. When the electrical device 400 is properly mounted, the mounting groove 232 aligns with a latching notch on the electrical device 400, the spring latch 233 extends from the mounting groove 232 and engages with the latching notch, and the conductive assembly 300 is electrically connected to a conductive contact 420 of the electrical device 400, such that the electrical device 400 is fixed to and electrically connected to the track connector power supply module 10, ensuring that the electrical device 400 can follow the track connector power supply module 10 to move freely, and ensuring that the electrical device 400 is powered.

Further, as shown in FIGS. 7 and 8, the conductive assembly 300 includes a first conductive bump 310, a second conductive bump 320, and a conductive structure 330, Specifically, the first conductive bump 310, the conductive structure 330, and the second conductive bump 320 are connected in sequence. Further, the first conductive bump 310 is fixed in the first bump through-hole 121, one end of the first conductive bump 310 extends to an inner side of the sliding assembly 100, and extends from the sliding assembly 100 to abut against the conductive track 500, and the other end of the first conductive bump 310 extends to an outer side of the sliding assembly 100 and extends from the sliding assembly 100 to abut against the conductive structure 330, to form a conductive path. Further, the conductive structure 330 is a copper ring, the conductive structure 330 is shaped to match a shape of the annular rib 130, and the two conductive structure 330 are respectively disposed on both sides of the annular rib 130 and correspond to one of the first bump through-holes 121, respectively, so as to guarantee conductive paths between the two first conductive bumps 310 and the conductive structures 330. Further, the conductive structure 330 is fixedly accommodated in the receiving groove 210 of the rotary assembly 200, such that the conductive structure 330 can follow the sliding assembly 100 to move synchronously. In addition, when the rotary assembly 200 rotates relative to the sliding assembly 100, it is ensured that the conductive structures 330 are electrically connected to the first conductive bump 310 and the second conductive bump 320. Further, the second conductive bump 320 is fixed in the second bump through-hole 231, one end of the second conductive bump 320 extends to an inner side of the rotary assembly 200, and extends from the rotary assembly 200 to abut against the conductive structure 330, the other end of the second conductive bump 320 extends to an outer side of the rotary assembly 200 and is parallel to the surface of the mounting surface 230, the mounting of the electrical device 400 on the mounting surface 230 of the rotary assembly 200 is not affected, and it is ensured that the second conductive bump 320 is electrically connected to the conductive contact of the electrical device 400 after the electrical device 400 is mounted on the mounting surface 230. Further, the two second conductive bumps 320 are respectively disposed corresponding to the two conductive structures 330, so as to ensure that two conductive paths are formed between the electrical device 400 and the conductive track 500. Further, a spring plunger is disposed inside each of the first conductive bump 310 and the second conductive bump 320, and the spring plunger is configured to ensure that both ends of the first conductive bump 310 and the second conductive bump 320 can be freely extended and retracted; a length of the first conductive bump 310 is set to be greater than the length of the first bump through-hole 121, to ensure that the first conductive bump 310 abuts against both the conductive track 500 and the conductive structure 330. Similarly, a length of the second conductive bump 320 is set to be greater than a length of the second bump through-hole 231, to ensure that the second conductive bump 320 abuts against both the conductive structure 330 and the conductive contact of the electrical device 400, thus ensuring an electrical connection between the conductive track 500 and the electrical device 400 during use.

Further, as shown in FIGS. 7 and 8, in this embodiment, a snap-fit structure 410 corresponding to the track connector power supply module 10 is disposed on the electrical device 400, the snap-fit structure 410 is disposed in a way of matching the connecting structure 240 on the track connector power supply module 10, and the snap-fit structure 410 is inserted into the connecting structure 240 configured as the snap-fit slot to complete the snap-fit connection between the electrical device 400 and the track connector power supply module 10. Further, as shown in FIG. 8, the conductive contact 420 is disposed in a position of the electrical device 400 in alignment with the second bump through-hole 231 on the track connector power supply module, and a latching slot 430 is disposed in a position of the electrical device 400 in alignment with the mounting groove 232 on the track connector power supply module 10, so as to ensure that the spring latch 233 engages with the latching slot 430 to lock the connection when the electrical device 400 is connected to the track connector power supply module 10, and the conductive contact 420 abuts against the second conductive bump 320 in the second bump through-hole 231, forming a conductive path to supply power to the electrical device 400.

Further, as shown in FIG. 4, the electrical device 400 is provided with a pivot structure, a latching tooth 440 and a plurality of latching tooth slots 450 corresponding to the latching tooth 440 are disposed on the pivot structure, and the latching tooth slots 450 are engaged with the latch tooth 440. In this way, by inserting the latch tooth 440 into different latching tooth slots 450, an angle of the electrical device 400 in an axial plane of the conductive track 500 can be adjusted. When the conductive track 500 is vertically placed and the electrical device 400 is connected to the track connector power supply module 10, the sliding assembly 100 can drive the track connector power supply module 10 to slide along the conductive track 500, thereby adjusting a height of the electrical device 400; the rotary assembly 200 can drive the track connector power supply module 10 to rotate about the conductive track 500, such that the electrical device 400 can be adjusted to a desired angle in a horizontal direction; and finally, by the cooperation between the latching tooth 440 and the latching tooth slots 450, the electrical device 400 is rotated in an axial direction relative to the conductive track 500, such that a desired angle of the electrical device 400 in a vertical plane can be determined. By using the track connector power supply module 10 in combination with different structures on the electrical devices, the user can be provided different functions such as lighting, charging, or power supply at different heights, angles, and orientations. By positioning objects in different angle, space utilization is optimized, usage scenarios of different electrical devices are expanded. Therefore, the track connector power supply module 10 is beneficial for further market promotion.

In this embodiment, after being assembled, a plurality of the track connector power supply modules 10 can be sequentially sleeved on the conductive track 500, and positions and orientations of the track connector power supply modules 10 on the conductive track 500 can be set as needed. As shown in FIGS. 1 and 2, after the plurality of the track connector power supply modules 10 10 are sleeved on the conductive track 500, when the electrical device needs to be connected, the electrical device 400 is connected to the corresponding track connector power supply module 10 as needed, to realize the setting of electrical devices in different positions and orientations. When a position of one of the electrical devices 400 needs to be adjusted, it is only necessary to remove the electrical device 400 from the track connector power supply module 10, and remounted on the corresponding track connector power supply module 10, to complete the exchange between different electrical devices 400, making the operation simple and fast, and convenient for the user to operate. In this embodiment, the electrical device 400 includes an LED light, a USB charging connector, and a wireless charging tray. By adjusting the height, angle, and orientation of the electrical device 400 relative to the conductive track 500, the user can be provided with functions such as lighting and charging in a specific direction. In addition, adjacent electrical devices can be disposed in a staggered manner to further improve a space utilization rate.

In the present disclosure, the electrical device 400 can be quickly mounted on and removed from the track connector power supply module 10 through the mounting surface 230 and the connecting structure 240. Moreover, the sliding assembly 100 enables track connector power supply module 10 to slide along the conductive track 500, and the orientation of the electrical device 400 in the horizontal plane can be adjusted through the rotary assembly 200, and conductive assembly 300 ensures that the electrical device 400 is electrically connected to the conductive track 500 at any time, so as to ensure that a continuous working state of the electrical device 400. In this way, positions and orientations of different electrical devices 400 can be quickly adjusted, and an order of the different electrical devices 400 can be changed through quickly mounting and removal, providing the user with more customized lighting, charging, or power supply functions, which is convenient for users to use, and being convenient for the user to operate.

In summary, the present disclosure provides a track connector power supply module, including a sliding assembly configured to match the conductive track, and the electrical device sliding along the conductive track through the sliding assembly; a rotary assembly sleeved on an outer side of the sliding assembly, and the rotary assembly capable of rotating about the sliding assembly; where a mounting surface is formed on an outer side of the rotary assembly, a connecting structure is disposed around the mounting surface, and the electrical device is detachably connected to the rotary assembly via the connecting structure; and a conductive assembly, one end of the conductive assembly is disposed on a side of the sliding assembly facing the conductive track and abuts against the conductive track, and the other end of the conductive assembly extends through the mounting surface and is electrically connected to the electrical device. By setting up a modular electrical connector structure, the present disclosure simplifies the steps of changing the order of different electrical devices on the conductive track, that is, it is only necessary to remove and remount the corresponding electrical device to the desired position, with no need to remove all the electrical devices from the conductive track and mount again, making the operation more convenient and efficient.

It should be understood that the application of the present disclosure is not limited to the above examples. For those ordinarily skilled in the art, improvements or variations can be made based on the foregoing description, and all these improvements or variations shall fall within the scope of protection of the appended claims of the present disclosure.

What is claimed is:

1. A track connector power supply module, wherein the track connector power supply module is sleeved on a conductive track in a sliding manner to fix an electrical device on the conductive track and provide an electrical connection for the electrical device, comprising:
a sliding assembly, wherein the sliding assembly is configured to match the conductive track, and the electrical device slides along the conductive track through the sliding assembly;
a rotary assembly, wherein the rotary assembly is sleeved on an outer side of the sliding assembly, and the rotary assembly is capable of rotating about the sliding assembly; wherein a mounting surface is formed on an outer side of the rotary assembly, a connecting structure is disposed around the mounting surface, and the electrical device is detachably connected to the rotary assembly via the connecting structure; and
a conductive assembly, wherein one end of the conductive assembly is disposed on a side of the sliding assembly facing the conductive track and abuts against the conductive track, and the other end of the conductive assembly extends through the mounting surface and is electrically connected to the electrical device.

2. The track connector power supply module according to claim 1, wherein the conductive assembly comprises:
a first conductive bump, wherein the first conductive bump is fixed in the sliding assembly and extends from the sliding assembly toward the conductive track to abut against the conductive track;
a conductive structure, wherein the conductive structure is disposed between the sliding assembly and the rotary assembly, and one side of the conductive structure is connected to the first conductive bump; and
a second conductive bump, wherein the second conductive bump is fixed in the rotary assembly, one end of the second conductive bump keeps abutting against the other side of the conductive structure when the rotary assembly rotates, and the other end of the second conductive bump extends through the mounting surface and is electrically connected to the electrical device.

3. The track connector power supply module according to claim 2, wherein a spring plunger is disposed inside each of the first conductive bump and the second conductive bump, such that the first conductive bump is maintained in a state of extending from the sliding assembly to abut against the conductive track, and the second conductive bump is maintained in a state of extending from the rotary assembly to abut against the conductive structure.

4. The track connector power supply module according to claim 2, wherein the sliding assembly comprises:
a body, wherein the body is an annular structure to be sleeved on the conductive track;
a boss, wherein the boss is disposed on an inner side of the body and is snap-fitted with the conductive track; and when the sliding assembly slides along the conductive track, the boss is configured to prevent relative rotation between the sliding assembly and the conductive track; and
an annular rib, wherein the annular rib is disposed around the body on a circumference of the body, and the annular rib is assembled with the body to form the conductive structure.

5. The track connector power supply module according to claim 4, wherein two first bump through-holes penetrating through the body are formed on the boss, the first conductive bump is fixed in the first bump through-holes, and the first bump through-holes are disposed on both sides of the annular rib to correspond to the conductive structures respectively disposed on the both sides of the annular rib; wherein the conductive structure is a copper wire ring, and the two conductive structures are disposed around the body on the both sides of the annular rib.

6. The track connector power supply module according to claim 3, wherein the rotary assembly is an annular structure, an inner side of the rotary assembly is provided with a receiving groove in a circumferential direction to accommodate the sliding assembly and the conductive structure, and the second conductive bump abuts against the conductive structure, such that the sliding assembly and the conductive structure are eccentrically disposed relative to the rotary assembly, and the track connector power supply module is locked on the conductive track.

7. The track connector power supply module according to claim 6, wherein an unlocking member is disposed on a side of the rotary assembly away from the mounting surface, the unlocking member abuts against the sliding assembly to push the unlocking member to move toward the sliding assembly and the conductive structure, such that the sliding assembly and the conductive structure are concentrically disposed relative to the rotary assembly, and the track connector power supply module is released from the conductive track.

8. The track connector power supply module according to claim 2, wherein a snap-fit slot is formed between the mounting surface and the rotary assembly as the connecting structure, so as to match the electrical device, and a detachable connection between the electrical device and the rotary assembly is achieved.

9. The track connector power supply module according to claim 5, wherein two second bump through-holes penetrating through the rotary assembly are formed on the mounting surface, the second bump through-holes are respectively disposed corresponding to the conductive structures on the both sides of the annular rib, and the second conductive bump is fixed in the second bump through-holes.

10. The track connector power supply module according to claim 8, wherein a mounting groove is formed on the side of the mounting surface away from the rotary assembly, and a spring latch is fixedly disposed in the mounting groove, so as to secure the electrical device when the electrical device is connected to the rotary assembly.
